(19) United States
(12) Patent Application Publication
(10) Pub. No.: US 2025/0179843 A1
(43) Pub. Date: Jun. 5, 2025

(54) Closure element actuation recognition

(71) Applicant: MinebeaMitsumi Inc., Nagano (JP)

(72) Inventors: Sebastian Rettenberger, Mering (DE); Martin Winker, Wurmlingen (DE); Luis Antonio Roca Pita, Munich (DE)

(73) Assignee: MinebeaMitsumi Inc., Nagano (JP)

(21) Appl. No.: 18/966,848

(22) Filed: Dec. 3, 2024

(30) Foreign Application Priority Data
Dec. 4, 2023 (DE) 102023133843.9

(51) Int. Cl. E05B 81/76

(52) U.S. Cl. CPC E05B 81/76

(57) ABSTRACT

The present invention relates to a method for recognizing an actuation of a closure element (10) of a motor vehicle. The method at least comprises a step of detecting an actuation force profile acting on the closure element (10), in particular a handle element (12) of the closure element (10). In addition, the method comprises a step of recognizing (22) an actuation event in dependency of the detected actuation force profile. In addition, the invention relates to a system for recognizing an actuation of a closure element (10) of a motor vehicle.

### CROSS-REFERENCE TO RELATED APPLICATIONS

This application claims priority to German Application No. 102023133843.9, filed Dec. 4, 2023, which is herein incorporated by reference in its entirety.

### TECHNICAL FIELD

Embodiments of the present invention relates to a method for recognizing an actuation of a locking element of a motor vehicle. Furthermore, embodiments of the invention relates to a system for recognizing an actuation of a locking element of a motor vehicle.

### STATE OF THE ART

With conventional doors of motor vehicles, these are released and opened by pulling on a door handle. A movable door handle that is pivoted by pulling on the door handle releases the door through a mechanical connection with a lock. The user can then open the door using muscle power.

However, vehicle doors can also be automatically unlocked and/or opened by a motor. This, however, also requires some form of actuation, such as pulling or touching a door handle. By motor-driven adjusting and releasing the door, a mechanical connection between the door handle and the lock can be forfeited. Likewise, the door handle itself can be immovable, since no force and movement should be transmitted mechanically to the door lock. In this case, it can be important that the actuation of the door is reliably recognized so that there is no unwanted adjustment of the door.

DE 10 2021 112 324 A1 describes a system for recognition of an input and control of a downstream device, whereby a time-varying input signal in the form of a movement is detected. In this way, a user's movement is detected by a sensor apparatus and an evaluation or analysis of this movement is conducted and interpreted. The system can be used for opening a car tailgate.

### DESCRIPTION OF THE INVENTION

A first aspect of the present invention relates to a method for recognizing an actuation of a closure element of a motor vehicle. The actuation of a closure element can be a handling which corresponds to a user's request for adjustment. For example, an actuation can be pulling on the closure element or pressing on the closure element, in particular on a predefined spot. A closure element can, for example, be designed as a door or tailgate. However, a closure element can also be designed as a window, folding roof or sliding roof of the motor vehicle. The closure element can, for example, be adjustable between an open position, in which an access opening to the motor vehicle is at least partially unblocked, and a closed position, in which the access opening is blocked. The closure element can, for example, be pivoted unilaterally on a chassis of the motor vehicle. The closure element can be designed for automatic adjusting. For example, the tailgate of the motor vehicle can be pivotable by a motor between its closed position and its open position. In the process, a lock can also be unlocked and/or released. Adjusting can occur, for example, in reaction to a recognized actuation of the closure element. The closure element can comprise an adjusting motor. For example, the tailgate can be adjustable by means of a spindle drive. The motor vehicle can be designed, for example, as a passenger car or a truck.

The method comprises a step of detecting an actuation force profile acting on the closure element. An actuation force may be an external force acting on the closure element. The actuation force may be caused by a user, for example. A profile of an actuation force may be an actuation force at at least two different points in time. For example, the actuation force may be detected continuously as an analog signal. However, the actuation force can also be detected at discrete intervals, for example at a measuring frequency of a sensor, for detecting the actuation force profile. One or more force sensors can be intended for the detection. For example, a force sensor can be designed as a strain gauge. It can then be inferred to a force acting on a stiff and/or immovable part of the closure element by means of a deformation of said part.

The detection can be permanently active or triggered by an activation signal. For example, the detection can be activated when a radio key for the motor vehicle approaches below a minimum distance and/or when a state of the motor vehicle is unlocked. The actuation force profile can comprise a force direction. For example, the force direction can be detected as vector. It is also possible, for example, to distinguish only between a pulling force and a pushing force, for example by means of a sign of the actuation force. Thus, different reactions depending on force direction occur. However, it is also possible to detect only an absolute magnitude of the actuation force for the actuation force profile.

An actuation force can also be filtered to detect the actuation force profile. For example, a raw signal from respective force sensors can be filtered with a low-pass filter. Thus, interference signals can be reduced.

For example, the actuation force acting on a handle element of the closure element can be detected. A handle element can be designed, for example, as door handle or as another actuation element, such as a logo of the car manufacturer. A handle element can be designed, for example, as a rigid component. The handle element can be arranged immovably or movably on the rest of the closure element. For example, only the actuation force acting on the handle element can be detected. Respective sensors can be arranged on or in the handle element. Thus, forces that are not intended for actuation, such as pressing against a door surface distanced from the handle element, can categorically be ignored.

The method comprises a step of detecting an actuation event in dependency of the detected actuation force profile. An actuation event may correspond to an actual actuation request. With this, it can be distinguished from other forces acting on the closure element, for example due to wind, weather, animals and/or cleaning of the motor vehicle. For example, an actuation event may be pulling in a specific manner by a user on the door handle. In contrast, pulling on the door handle by a washing textile in a car wash is not an actuation event. This way, unwanted door opening can be avoided, for example.

The actuation event can be recognized, for example, by means of a pattern match, a comparison with threshold values, values derived from the actuation force profile and/or by means of a trained neural network. The neural network can be trained for this beforehand with synthetic or experimentally generated training data. Respective comparison data, such as patterns and/or threshold values, can be closure element-specific. For example, an actuation force profile corresponding to an actuation event can depend on a shape, a material and/or other properties of the closure element and/or the handle element. The recognizing of the actuation event can comprise a distinction from forces acting on the closure element due to causes other than actuation. The method can also comprise a recognizing of non-actuation events, such as passing through a car wash.

In reaction to the recognizing of the actuation event, an opening of the closure element can occur. The opening can comprise an unlocking and/or an adjusting of the closure element in the direction of the open position. It can also be responded to the actuation event with an automatic closing of the closure element, for example if the closure element is in the open position. The closing can comprise an adjusting of the closure element in the direction of the closed position and/or a locking.

Different actuation events can also be recognized. For example, a first actuation event can cause the opening of the closure element and a second actuation event can cause the closing of the closure element. It can be distinguished between the various actuation events, for example, based on respective patterns and/or a force direction. For example, when pressing against the door handle as actuation event when the door is in closed position it can be locked, whereas when pulling on the door handle as actuation event when the door is in closed position the door can be opened.

In a further embodiment of the method, it may be provided that the method comprises a step of detecting a temperature of the handle element. Detecting the temperature of the handle element can occur with an integrated temperature sensor of a control device. The control device can be arranged in, on or adjacent to the handle element. The step of detecting can be conducted once or several times, for example at periodic intervals. The temperature can then be detected, for example, in the form of a temperature profile as a function of time. The control device may, for example, be an evaluation device and may, for example, be configured to execute some or all the steps of the method for recognizing an actuation of the closure element. The temperature sensor of the control device may be a temperature sensor implemented in the control device. For example, the control device may comprise a microcontroller and the temperature sensor may be a temperature sensor integrated on a circuit board of the microcontroller.

Alternatively, or additionally, a dedicated temperature sensor may be provided, for example in and/or on the handle element, which is designed for detecting the temperature of the handle element. There may also be several temperature sensors, of which, for example, at least one is integrated into the control device and at least one is arranged on or in the handle element. With a temperature sensor on or in the handle element, temperature can be detected at a location near the handle element, for example on the handle element made of plastic. With a temperature sensor of the control device a temperature may be detected, for example, closer to a metallic part on which the handle element itself may be arranged. Due to different thermal conductivity of plastic and metal, a slight time offset in detecting the temperature of the handle element can be reduced.

At least one of detecting the actuation force profile and recognizing the actuation event may be conducted in dependency of the detected temperature of the handle element. For example, exactly one of detecting the actuation force profile and recognizing the actuation event may be conducted in dependency of the detected temperature of the handle element. For example, exactly one of detecting the actuation force profile and recognizing the actuation event may be conducted independently of the detected temperature of the handle element. Alternatively, both detecting the actuation force profile and recognizing the actuation event may be conducted in dependency of the detected temperature of the handle element. Thus, for example, a different deformation behavior of the handle element during force detection may be taken into account.

The sensor, for example a force sensor, for detecting the actuation force profile can be parameterized in dependency of the detected temperature of the handle element. Thus, an actuation force profile detected with the same sensor for a first temperature may be different from an actuation force profile detected with the sensor at a second temperature different from the first temperature, although the same force may act on the sensor in both cases. However, a different force may act on the handle element in the two cases, and a temperature dependency when detecting the actuation force profile can be compensated for by means of the dependency of detecting the actuation force profile on the temperature of the handle element. Thus, for example, a corresponding temperature curve for a corrected detecting of the actuation force profile may be deposited for different temperatures, for example in a memory of the sensor, such as the force sensor, and/or in the control device, which may be configured, for example, for recognizing the actuation event.

For example, a criterion for recognizing the actuation event can be modified in dependency of the detected temperature of the handle element. For example, at least one criterion for recognizing the actuation event can be modified in dependency of the detected temperature of the handle element. For example, at least one of a threshold value, a pattern, comparison data, and/or other values derived from the actuation force profile may be changed. Alternatively, or additionally, a neural network may be trained accordingly to take into account the detected temperature of the handle element as a criterion and thus as an input variable. Thus, for example, an actuation event for a specific actuation force profile can be recognized at a first temperature, whereas an actuation event for the same actuation force profile cannot be recognized at a second temperature that is different from the first temperature. Thus, recognizing the actuation event may be dependent on the temperature of the handle element.

For example, a stiffness, for example of a plastic sleeve of the handle element, changing with the temperature of the handle element can be compensated when detecting the actuation force profile and/or when recognizing the actuation event. A temperature curve of the handle element deposited for this compensating may represent a dependency of the actuation force profile on certain temperatures. This dependency may, for example, be linear, quadratic or generally polynomial, or it may be exponential or logarithmic.

In a further embodiment of the method, at least one of detecting the actuation force profile and recognizing the actuation event may be conducted in dependency of an age of the handle element, for example a plastic sleeve of the handle element. Alternatively, or additionally, at least one of detecting the actuation force profile and recognizing the actuation event may be conducted in dependency of an age of the closure element.

For example, a temporal update of the temperature curves can be conducted. This way, aging of the closure element and/or the handle element can be compensated. Thus, for example, a plastic handle that has hardened over time as a handle element may lead to a modified actuation force profile when detecting the actuation force at the handle element due to a modified stiffness of the material and/or sensor degradation.

For example, a criterion for recognizing the actuation event can be modified in dependency of the age of the handle element and/or closure element. For example, at least one criterion for recognizing the actuation event can be modified in dependency of the age of the closure element and/or the handle element. For example, at least one of a threshold value, a pattern, comparison data, and/or other values derived from the actuation force profile may be changed. Alternatively, or additionally, a neural network may be trained accordingly to take into account the age of the handle element and/or the closure element as criteria and thus as input variables. This means that, for example, an actuation event for a specific actuation force profile may be recognized for a first age, whereas an actuation event for the same actuation force profile is not recognized for a second age that is different from the first age. Thus, recognizing the actuation event may be dependent on the age of the closure element and/or the handle element.

The method may further comprise a step of determining the age of the closure element and/or the handle element. For example, the step of determining the age may comprise a step of detecting the age. For example, the age can be determined by starting a timer, for example when the method is conducted for the first time. Thus, an age of the closure element and/or the handle element can easily be determined. For example, the timer can be reset when a new closure element and/or handle element is installed.

In a further embodiment of the method, it may be provided that detecting the actuation force profile comprises detecting a first actuation force profile with a first sensor and detecting a second actuation force profile with a second sensor. The first and second sensor may be spatially spaced apart from one another. The first and second sensor may detect the first and second actuation force profile independently of one another. The first and second sensor may be a first and second force sensor. The actuation force profile may comprise the first and second actuation force profile or consist of them. Alternatively, the actuation force profile may comprise exactly one of the first and second actuation force profile or consist of it.

So, for example, a redundancy in the event of a faulty or non-existent first or second actuation force profile, for example due to a faulty first or second sensor, may be provided. For example, it may be distinguished whether there is in a first or second actuation force profile an error or a real effect, such as an actuation request, in the actuation force profile. Thus, detecting the actuation force profile may be conducted as a single evaluation and then in dependency of only one of the first actuation force profile and the second actuation force profile. Alternatively, a mean value of the first and the second actuation force profile may be determined as the actuation force profile. Thus, for example, the actuation force profile may be determined based on the first and second actuation force profile.

In a further embodiment of the method, it may be provided that the method comprises a step of determining an application point of an actuation force and/or a direction of an actuation force based on the detected first and second actuation force profile. For example, at least one of the application point and the direction of the actuation force can be determined by comparing the first and second actuation force profile. For example, a vectorization of the actuation force profile may be conducted in this way. For example, a relative force profile, which may be determined by comparing the first and second actuation force profile, may reflect the direction of the actuation force acting on the handle element. Accordingly, three, four or more sensors may be provided for this purpose, detecting corresponding actuation force profiles.

The first and second sensor may be arranged differently. In a first embodiment, the first sensor may be arranged on an upper part and the second sensor on a lower part of the handle element. For example, the direction of the actuation force can be well determined in a vertical direction. Alternatively, the first sensor may be arranged on a left side and the second sensor on a right side of the handle element. Thus, for example, the actuation force can be well determined in a horizontal direction. The application point can also be determined vertically and/or horizontally that way. For example, the first sensor may be arranged at an upper left corner of the handle element and the second sensor at a lower right corner of the handle element. Thus, for example, the application point can be determined both in the vertical and horizontal direction. The direction of the actuation force may also be determined in both, for example, the vertical and horizontal direction. If there are more than two sensors, a combination of some or all the arrangements discussed above may be intended.

In one embodiment, at least one of the application point and the direction of the actuation force can be determined based on the detected first and second actuation force profile, at least at times when both the first and second actuation force profile can be detected. If, at other times, for example due to a faulty first or second sensor, the first or second actuation force profile cannot be detected correctly, determining the application point and the direction of the actuation force may be dispensed with. In this case, only an absolute value of the actuation force can be determined without, for example, determining the application point and/or the direction of the actuation force.

In a further embodiment of the method, it may be provided that recognizing the actuation event comprises comparing the first and second actuation force profile. An actuation event for a particular point in time may be recognized, for example, if the actuation event is recognized in both the first and second actuation force profile. Alternatively, or additionally, a particular actuation event may be recognized by comparing the first and second actuation force profile. For example, it can be recognized that the handle element is being pulled or pushed by a user with a certain force, with a certain application point and/or with a certain direction of the actuation force. When comparing the first and second actuation force profile, the entire force profile can be compared. Alternatively, or additionally, individual criteria of the first and second actuation force profile, such as a level or a slope of the actuation force profile, can be compared with each other. Recognizing the actuation event may then be conducted based on comparing the entire first and second actuation force profile and, alternatively or additionally, comparing individual criteria of the first and second actuation force profile.

In a further embodiment of the method, it may be provided that detecting the actuation force profile is conducted at a reduced sampling rate after a specific time period without recognizing an actuation event. The specific time period may be one or more seconds, minutes, hours, days, or months. For example, no actuation event may be recognized in the specific time period. For example, an actuation event may be recognized at a first point in time. Immediately thereafter, the actuation force profile can be detected at a first sampling rate. The first sampling rate may, for example, be 20, 50 or 100 ms. After a specific time period, such as a week, the sampling rate may be reduced, for example to a sampling rate of once per second or once per 10 seconds. With such a second sampling rate, which is lower than the first sampling rate, detecting the actuation force profile can be conducted, for example until an actuation event is recognized again. If an actuation event is recognized, the second sampling rate can be changed back to the first sampling rate, thus increasing the sampling rate, for example.

Thus, a power-saving mode can be implemented with this method, whereby detecting the actuation force profile is conducted at a reduced sampling rate when the motor vehicle has been parked for a long time, for example. Thus, it may be ensured on the one hand that a user's request for actuation of the closure element is recognized sufficiently quickly, while at the same time detecting the actuation force profile at specific times does not have to be conducted too often, thus saving power. In addition, a probability of an erroneous recognition of an actuation event may be reduced due to the reduced sampling rate, since, for example, an object falling onto the handle element will only exert force on the handle element once.

The time period for the reduction of the sampling rate may also be determined, for example, in dependency of a battery charge state. Alternatively, the time period for the reduction of the sampling rate may be fixedly preset. There may be one or more specific time periods. Thus, one or more sampling rates may be assigned to one or more specific time periods. For example, a specific sampling rate may be assigned to a specific time period and different time periods may be assigned different sampling rates. For example, the sampling rate may be further reduced as the time period increases. Alternatively, or additionally, the time period may be determined not only in dependency of the battery charge state, but also in dependency of a temperature, for example an ambient temperature of the motor vehicle, and an age, for example of a battery, which may power a control device for executing the method.

In a further embodiment of the method, it may be provided that the step of recognizing the actuation event comprises calculating an actuation probability. The actuation probability may, for example, be calculated as a percentage, where 100% is a definite actuation and 0% is definitely no actuation. The actuation probability may be calculated by a fusion of a plurality of probabilities. For example, several data, such as an absolute magnitude of a maximum actuation force and its duration, may be compared with threshold values. A distance from the threshold value may correspond to a probability. These probabilities may be multiplied, for example, for calculating the actuation probability. The actuation event may be recognized if the calculated actuation probability is greater than a first threshold value. The first threshold value may be fixedly preset, for example at 90%. By usage of an actuation probability, it can be avoided that many actuation events are not recognized, and the closure element does thus not react. Thus, a user acceptance can be at a high level.

The first threshold value may also be determined in dependency of the detected actuation force profile. For example, in case of a lot of interference signals and vibrations, which can be contained in the actuation force profile, the first threshold value may be high. Thus, the probability of an erroneous recognition of an actuation event can be reduced in potentially harmful situations, such as a car wash, and/or in the event of other strong external force impacts. Likewise, another non-actuation event, such as driving through a car wash, can be recognized in dependency of the detected actuation force profile and the first threshold value can be increased for a non-actuation event. Thus, it may be necessary for a user to actuate the door more forcefully or particularly clearly in order for it to be opened nonetheless.

In a further embodiment of the method, it may be provided that a wake-up signal is generated when the calculated actuation probability is greater than a second threshold value. The second threshold value may be smaller than the first threshold value. The wake-up signal may, for example, be a trigger signal. The wake-up signal may, for example, be transmitted via a CAN data bus of the motor vehicle. With the wake-up signal, an ECU of the motor vehicle and/or of the closure element may be woken up. By the wake-up signal, a current feed of actuators may be activated, authentication of an access authorization may be started and/or further measures in preparation for adjustment of a closure element may be initiated. By the wake-up signal the closure element may, for example, instantly or even immediately be unlocked and/or adjusted into its open position as soon as the actuation event has been recognized. A low actuation probability is therefore used, for example, to prepare for a door opening, even if this low actuation probability is not yet sufficient to cause the actual door opening. Thus, a reaction speed may be increased without increasing a risk of an undesired adjustment. For example, no actuation event has yet been recognized at generation of the wake-up signal. The second threshold may be fixedly preset or, like the first threshold, variably preset. In addition, the second threshold may also comprise a fixedly preset difference to a first threshold that is variably determined as described above.

In a further embodiment of the method, it may be provided that the actuation force profile comprises a level, a slope and a standard deviation as properties. For example, the actuation force profile may comprise a level, a slope and/or a standard deviation at one or more points in time, such as at each point in time. For example, the actuation force profile may comprise a level, a slope and/or a standard deviation in a time range. For example, the level may be an absolute value of the actuation force at a specific point in time. The slope may be a first derivative of the actuation force profile at a specific point in time. The slope may be an average slope of the actuation force in a specific time range. The standard deviation may be with respect to multiple values of the actuation force in a time range and a mean value of the actuation force in the time range. Thus, the standard deviation may define a spread width of the multiple values of the actuation force in the time range about the mean value of the actuation force in the time range. The standard deviation may be a measure of signal noise.

Furthermore, calculating the actuation probability may comprise calculating individual probabilities for an actuation. The individual probabilities for an actuation can, in each case, only be calculated in dependency of one of the properties. For example, an individual probability for an actuation can be calculated for the level. Furthermore, an individual probability for an actuation can be calculated, in each case, for the slope as well as for the standard deviation. For example, the individual probability for an actuation for, in each case, one of the level, the slope and the standard deviation can be calculated via a functional relationship between the level, the slope or the standard deviation and a probability. Calculating may be conducted, for example, by means of a neural network that has been trained accordingly. Thus, calculating the individual probabilities can correspond particularly accurately to an actual probability. Alternatively, or additionally, calculating can be conducted using look-up tables. In this case, calculating can be conducted very quickly and with little computational effort. These look-up tables may have been previously determined based on large amounts of test data. Furthermore, the neural network may also have been trained with test data.

The actuation force profile can be plotted as a function of time, whereby a force can be plotted against time. The calculated individual probabilities can also be plotted on the same time scale. Thus, for example, an individual probability for the level, the slope and the standard deviation can be plotted for each point in time. The individual probabilities can be calculated for a time period of the actuation force profile, for example for a specific time window before the last detection of actuation forces.

The actuation probability may be calculated based on at least one of the calculated individual probabilities. For example, the actuation probability may be calculated based on all calculated individual probabilities. For example, the actuation probability may be calculated for each point in time or time range for which the actuation force is also available as an actuation force profile. For example, the actuation probability may be calculated for a specific point in time based on and in dependency of the individual probabilities at this point in time. Thus, for example, the actuation probability, or the overall actuation probability, may be calculated by averaging or multiplication of the individual probabilities. Alternatively, the actuation probability, or overall actuation probability, may be calculated by integrating the individual probabilities. Thus, the actuation probability may be calculated easily and with little computational effort by calculating the individual probabilities.

In a further embodiment of the method, it may be provided that the same value is calculated for the individual probability in, in each case, one range of the respective property. A functional relationship that maps a value of the property to the individual probability of the property can be constant in the range, for example, neither increasing nor decreasing. Different values of the properties may be mapped to the same individual probability value. There may be one or more such ranges. Thus, for example, there may be a first range of a property, with values of this range being mapped to a first individual probability. There may be a second range that is different from the first range of the same property, with values of the second range being mapped to a second individual probability. The first and second individual probabilities may be different or identical.

At least one, for example exactly one, several or all properties may comprise at least one range in which the same value is calculated for the individual probability. For example, if the standard deviation is very small, the individual probability of the standard deviation may be 100%, for example up to a maximum threshold value of the standard deviation. If the standard deviation is below a maximum threshold, the individual probability may be 100%, and if the standard deviation is identical to or above the maximum threshold, the individual probability may be less than 100%. For example, the individual probability may then decrease with increasing standard deviation, such as linearly or quadratically.

Also, if the level has exceeded a specific threshold, the individual probability for the level may, for example, be 100%. Thus, the individual probability for the level may comprise a first value if the level is below a specific threshold. If the level is identical to or greater than this specific threshold but smaller than another specific threshold, the individual probability may comprise a second value, which may be greater than the first value. With increasing level, the individual probability of the level may increase, for example in stages.

If the slope is greater than a certain threshold and less than another certain threshold, then the individual probability for the slope may be 100%, for example. If the slope is outside this range, then the individual probability for the slope may be less than 100%. For example, in a specific range or corridor of the slope, the individual probability of the slope may be 100%, for example. Outside of this range or corridor, the individual probability may be smaller, for example 50% or 0%. Outside of the range or corridor, the individual probability may change with a changing slope, for example linearly or quadratically. Thus, the individual probability for an actuation based on the slope may be very high if the slope of the actuation force profile, i.e. a change over time of the actuation force profile, is in this range or corridor, i.e. the user applies an actuation force onto the handle element with a specific change over time.

In a further embodiment of the method, it may be provided that the actuation probability is calculated based on only one or two of the calculated individual probabilities. For example, the actuation probability may be calculated based on only one or two of the calculated individual probabilities if at least one of the individual probabilities exceeds a specific threshold. For example, if the level exceeds a specific individual probability, the activation probability may be determined based on the individual probability of the level alone. Alternatively, or additionally, starting from a specific value of a property, for example starting from a specific level, the actuation probability may be determined based on one calculated individual probability alone.

Furthermore, recognizing the actuation event can be verified by those individual probabilities that were not used for calculating the actuation probability. For example, the actuation probability may be calculated based only on the calculated individual probability of the level. Furthermore, a step of verifying of the recognizing may be conducted, wherein the step of verifying is conducted in dependency of individual probabilities for slope and standard deviation. Thus, for example, a quick opening of the closure element may be conducted based only on the calculated individual probability for the slope, in that the actuation event can be quickly recognized and verified only via the individual probability for the level.

In some cases, the level can be used as the only individual probability for calculating the actuation probability and thus for recognizing the actuation event. This can also be used to implement a power-saving function, since calculating the actuation probability can thus be conducted more easily and fewer calculation steps are necessary. This can also be done faster than if the actuation probability is calculated based on all calculated individual probabilities and all individual probabilities have to be calculated. Furthermore, the actuation force profile may not be continuous and may be mapped using a non-continuous function. Thus, for example, the slope cannot be determined for all points in time or ranges of the actuation force profile. In this case, it may be advantageous if the actuation probability is determined based only on the calculated individual probabilities for the level and/or the standard deviation. Thus, the executability of the method even exists if the detected actuation force profile cannot be mapped using a continuous function.

In a further embodiment of the method, it may be provided that recognizing the actuation event is conducted in dependency of the standard deviation. For example, a criterion for recognizing the actuation event may be modified. For example, at least one criterion for recognizing the actuation event may be modified in dependency of the standard deviation. For example, at least one of a threshold value, a pattern, comparison data, and/or other values derived from the actuation force profile may be changed. Alternatively, or additionally, a neural network may be trained accordingly to take into account the standard deviation as a criterion and thus as an input variable. Thus, for example, an actuation event may be recognized at a first standard deviation, whereas an actuation event cannot be recognized at a second standard deviation that is different from the first.

For example, a criterion for recognizing the actuation event can be changed by changing a threshold. For example, a threshold for recognizing the actuation event can be increased if the standard deviation increases. Thus, if, for example, the actuation force profile fluctuates more in a specific range, recognizing the actuation event can only be conducted at a higher level. If the standard deviation is even greater, the method for recognizing the actuation event may also be terminated or switched off, for example if it is recognized that the motor vehicle is in a car wash. Alternatively, or additionally, a range or corridor of at least one property may be reduced if the standard deviation is increased. If, for example, the standard deviation increases from a first point in time to a later second point in time, a range of a property, for example the level, for which the individual probability comprises a relatively high value, for example 100%, may be reduced. Thus, fewer values of the respective properties, thus, for example, fewer values of the level, may fall into this range and for fewer values of this level a high value of the individual probability, in this case 100%, may be output. Thus, if the standard deviation increases, the range or corridor may be reduced. Alternatively, or additionally, if the standard deviation increases, only the individual probability for the level or the slope can be determined and the actuation probability can be determined based only on this calculated individual probability.

In a further embodiment of the method, it may be provided that if the standard deviation is above a third threshold, calculating the actuation probability is conducted solely in dependency of the individual probability with respect to the level or the slope. For example, the actuation probability may be calculated either in dependency of the individual probability with respect to the level or in dependency of the individual probability with respect to the slope. For example, the actuation probability may be calculated in dependency of at least two, for example two or exactly two, individual probabilities with respect to two levels or two slopes at different times. Thus, for example, the actuation probability may be calculated in dependency of exactly two individual probabilities with respect to two levels at different times or points in time. Alternatively, the actuation probability may be calculated in dependency of two individual probabilities with respect to two slopes at different times or points in time. The actuation probability may be calculated in dependency of more than two individual probabilities with respect to several values of a property at different times. If the standard deviation is particularly large, it may be advantageous, for example, to use only the level or the slope, but not both values for calculating the actuation probability via the individual probabilities of the respective property.

In a further embodiment of the method, it may be provided that an actuation event is recognized when the slope is below a fourth threshold and the level is above a fifth threshold for a specific minimum duration. Thus, for example, an actuation may be recognized when a user actuates the handle element with a specific force, wherein the force does not change over time more than defined by the fourth threshold value, and at the same time the magnitude of the force, i.e. the level, is above the fifth threshold value for a specific minimum duration, meaning the user is pulling or pushing on the handle element with a specific minimum force.

A specific actuation event can be recognized in dependency of a sign of the slope. Thus, for example, it may be recognized that the user is pulling or pushing. Thus, attention may be paid only to a rising or falling edge in the actuation force profile.

In a further embodiment of the method, it may be provided that the method may comprise a step of detecting a speed of the motor vehicle. Detecting the speed of the motor vehicle may be conducted using a speed sensor. Recognizing the actuation event may, for example, be deactivated if the detected speed is greater than a threshold speed. For example, the threshold speed may be 3, 4 or 5 km/h. For example, an actuation event may only be recognized if the vehicle is moving maximally with the threshold speed. Thus, for example, it can be ensured that no actuation event is recognized if the vehicle is moving at more than the threshold speed. Thus, for example, a faulty recognition and thus faulty opening, for example of the closure element, during a ride may be prevented.

In a further embodiment of the method, it may be provided that an opening signal is generated if at least one parameter of the detected actuation force profile is greater than a bridging threshold value, irrespective of whether the actuation event has been recognized. The parameter may, for example, be a maximum tensile force in a detection time period. Alternatively, or additionally, the opening signal may be generated if, for example, a tensile force as actuation of the closure element exceeds a minimum tensile force for a minimum time period. If several parameters are taken into account, each parameter may be assigned a bridging threshold value. For the generation of the opening signal, for example, all, some or only one of the parameters must exceed its assigned bridging threshold value. The parameter may, for example, be a force or a derivative of the force. For example, the parameter may be a characteristic force profile and the respective bridging threshold values may represent a characteristic force profile. The bridging threshold value or the respective bridging threshold values may be limits at which the closure element is always opened, optionally provided an access authorization, irrespective of whether an actuation event has been recognized or not. This means that access to the motor vehicle is always possible in an emergency. The opening signal may also be generated, for example, when a non-actuation event, such as driving through a car wash, has been recognized. The opening signal causes, for example, an unlocking of the closure element and/or an adjustment of the closure element into the open position.

Respective bridging threshold values may be fixedly preset or determined in dependency of the detected actuation force profile. In the event of interference signals, e.g. vibrations, the bridging threshold may be increased, for example. It is also possible that a non-actuation event is recognized, such as driving through a car wash, in dependency of the detected actuation force profile and the bridging threshold value is increased in the event of a non-actuation event.

In a further embodiment of the method, it may be provided that the method comprises a step of determining a first derivative of the detected actuation force profile. The first derivative of the detected actuation force profile may be a gradient or a slope of the actuation force profile. Recognizing the actuation event may occur in dependency of the determined first derivative of the detected actuation force profile. By taking into account the first derivative of the detected actuation force profile it may be more precisely recognized whether the closure element is actually actuated by a user or forces act on the closure element in some other way, to which it should not be reacted with adjusting the closure element. For the recognition of the actuation event, the first derivative of the detected actuation force profile at solely one point in time or a profile of the first derivative of the actuation force profile may be used. For example, only a maximum magnitude of the first derivative of the detected actuation force profile may be determined and compared with a threshold value. It may also be provided an upper and a lower threshold value. The actuation event may be recognized, for example, if the first derivative of the detected actuation force profile is then within or alternatively outside a range defined by these threshold values. Alternatively, or additionally, a form of the first derivative of the actuation force profile may be considered and a comparison with a, for an actuation, characteristic profile of the first derivative of the actuation force profile may occur.

In a further embodiment of the method, it may be provided that the method comprises a step of determining a second derivative of the detected actuation force profile. Recognizing the actuation event may occur in dependency of the determined second derivative of the detected actuation force profile. The second derivative may be considered, for example, as an alternative or in addition to the first derivative. The second derivative may indicate whether a slope of the detected actuation force profile is decreasing or increasing. By taking into account the second derivative of the detected actuation force profile it can be recognized more precisely whether the closure element is actually being actuated by a user or forces are acting on the closure element in some other way, to which it should not be reacted with adjusting the closure element. For recognition of the actuation event, the second derivative of the detected actuation force profile at solely one point in time or a profile of the second derivative of the actuation force profile may be used. For example, only a maximum magnitude of the second derivative of the detected actuation force profile may be determined and compared with a threshold value. Alternatively, or additionally, a form of the second derivative of the actuation force profile may be considered and a comparison with a, for an actuation, characteristic profile of the second derivative of the actuation force profile may occur.

In a further embodiment of the method, it may be provided that the method comprises a step of determining an interference signal in dependency of the detected actuation force profile. An interference signal may, for example, be a part of the detected actuation force profile which is not caused by a force application by the user onto the closure element. The interference signal may, for example, be an oscillation or other periodic force. The interference signal may be caused by wind and/or weather, for example. The interference signal may be caused by passing vehicles. The interference signal may be recognized, for example, by its periodicity and/or respective derivatives of the detected actuation force profile. The interference signal may also be compared, for example, with known interference signals, for example from car washes, by means of a pattern match.

In a further embodiment of the method, it may be provided that recognizing an actuation event occurs in dependency of the determined interference signal. Therefore, the interference signal can, for example, be subtracted from the detected actuation force profile. Only after this subtraction can the corrected actuation force profile be used for recognizing the actuation event. Thus, recognizing the actuation event can be more reliable. Depending on the interference signal, a non-actuation event may also be recognized.

In a further embodiment of the method, it may be provided that at least one threshold value is determined in dependency of the determined interference signal. For example, all, some or only one of the threshold values described above may be set or changed in dependency of the determined interference signal. Thus, in the case of strong interference signals, for example, an actuation probability may be increased, from which on the actuation event is recognized and the closure element is opened.

In a further embodiment of the method, it may be provided that a force detection offset is taken into account when detecting the actuation force profile. Thus, also a correction of the detection may occur. For example, due to residual stress in the closure element, a temperature change and/or other influencing variables, there may be an offset in the detected force that is not caused by an actuation. These influencing variables can, for example, be detected and used for determination of the offset. For example, the temperature of the force sensor and/or the closure element can be detected and the force detection offset can be determined in dependency of the detected temperature. For example, the handle element may not fully deform back after actuation and a strain gauge as a force sensor may then permanently detect a force, which is not caused by an actuation. By taking this circumstance into account, the recognition of the actuation event may occur more reliably. By the force detection offset the detection may be calibrated, for example to a zero point.

In a further embodiment of the method, it may be provided that the force detection offset is determined in dependency of the detected actuation force profile. Thus, no additional sensors are required for detection of the offset. For example, the force detection offset can be determined as an average of the detected actuation force profile. The determination of the force detection offset may be suspended if a change of the detected actuation force profile is greater than a change threshold. For example, the average of the detected force for a certain preceding time period, for example 10 seconds and/or since a last suspension of the determination, may be determined as force offset. The average may be determined over a sliding time period. The average may also be taken overall since the motor vehicle was activated or last turned off, optionally suspended exposed time ranges due to exceeding the change threshold value. The suspension of the determination of the force detection offset may occur for a predetermined time period and/or until the change of the detected actuation force profile is less than the change threshold value. The suspension of the determination of the force detection offset may continue to occur for a predetermined time period after the change in the force profile is smaller than or identical to the change threshold value. The change may be a first derivative. For example, the determination of the force detection offset may be suspended when a gradient is greater than a maximum gradient. The change may, however, also be an absolute magnitude of a force difference at a given time interval, which must then be greater than the change threshold value for the suspension of the determination of the force detection offset. Due to the suspension of the determination of the force detection offset, temporary external influences, such as an actual actuation or disturbances, for example, from a car wash, can be ignored for calibration of a zero value for the force detection.

In a further embodiment of the method, it may be provided that the force detection offset can be taken into account via an analog compensation. For example, the force detection offset can be taken into account before amplifying the detected actuation force profile. For example, an absolute value of an output signal from the force sensor can be shifted via the analog compensation. The control device, which may be configured for recognizing the actuation event, may, for example, also be configured for controlling this analog compensation. Thus, for example, this control device may control a digital-to-analog converter via digital outputs, and the analog compensation may be conducted via this digital-to-analog converter. Multiple force sensors may be controlled via multiple digital-to-analog converters, which may be designed separately from the control device or integrated into it, via multiple different digital outputs of the control device. In doing so, several different analog compensations, for example one analog compensation per force sensor, may be conducted. Due to the analog compensation, in particular before amplifying, a resolution of the detected actuation force profile may be improved. This may improve the recognizing of the actuation event.

A second aspect relates to a system for recognizing an actuation of a closure element of a motor vehicle. The system may be designed for conducting the method according to the first aspect. Respective advantages and further features can be found in the description of the first aspect, whereby embodiments of the first aspect also form embodiments of the second aspect and vice versa.

The system comprises a force detection device which is designed to detect an actuation force profile acting on the closure element, in particular a handle element of the closure element. The system comprises an evaluation device which is designed to recognize an actuation event in dependency of the detected actuation force profile. The system may also comprise the closure element and/or the handle element. The handle element may be immovably attached to the rest of the closure element and/or be designed as a rigid component. The system may also comprise an actuator for the closure element. The system may comprise a control device that is designed to control the closure element in dependency of the recognized actuation event, for example to adjust the closure element between its closed position and open position.

In a further embodiment of the method, it may be provided that the force detection device comprises a strain gauge as a force sensor. The force detection device may also comprise several strain gauges. Thus, different deformation directions and thus force directions may be detected and/or distinguished particularly well. The force sensor may, for example, be arranged in or on the closure element. For example, the strain gauge may be glued onto the handle element or cast into the handle element.

In a further embodiment of the system, it may be provided that the force detection device comprises a strain gauge as a sensor, for example a force sensor. The features, advantages and embodiments described above with respect to the strain gauge as a force sensor with respect to the embodiment of the method are also applicable here with respect to the embodiment of the system.

The strain gauge may be designed as a Wheatstone measuring bridge. The Wheatstone measuring bridge may be a quarter, half or full bridge. For example, the Wheatstone measuring bridge may, for example, comprise four resistors. For example, the four resistors may be connected together to a closed ring or square. A supply voltage may be applied in one diagonal of the square. A voltage measuring device may be connected in another diagonal of the square.

In a further embodiment of the system, the force detection device may comprise a first force sensor and a second force sensor. The force detection device may comprise further force sensors. The first and second force sensor may be configured independently of one another for detecting the actuation force profile. For example, the system comprises two strain gauges as two separate and independent Wheatstone measuring bridges, for example designed as half bridges or full bridges.

In a further embodiment of the system, the system may comprise a first digital-to-analog converter for the first force sensor and a second digital-to-analog converter for the second force sensor. The two digital-to-analog converters may be realized on one circuit board or separately on different circuit boards. The two digital-to-analog converters may be realized together with the evaluation device on one circuit board or separately on a different circuit board from the evaluation device. Both digital-to-analog converters may be controlled via the digital outputs of the evaluation device. The first digital-to-analog converter may be controlled via first digital outputs and the second digital-to-analog converter may be controlled via second digital outputs that are different from the first digital outputs, for example independently of the first digital-to-analog converter.

The digital-to-analog converters may be configured for analog compensation of the actuation force profile by a force detection offset. Each of the digital outputs of the evaluation device may assume, for example, three states, 0, the supply voltage or high resistance. Each digital-to-analog converter may be connected to the evaluation device via four digital outputs. Each of the digital-to-analog converters may comprise four bits, for example, four different resistors. Each bit may be connected to a digital output of the evaluation device. Thus, 81 states can be realized. Thus, the resolution may be 81 instead of 16 with digital outputs with two states, namely 0 and the supply voltage. A certain behavior of the digital-to-analog converter can be achieved by a certain selection of the resistors of the bits of the digital-to-analog converter, for example certain factors between the resistors of the bits. For example, the resistors may differ from one another by a factor of 3. Thus, a first resistor may be three times as large as a second resistor. A third resistor may be three times as large as the second resistor. Thus, an almost linear behavior of the digital-analog converter with a linear resolution between the 81 states can be achieved. Via other factors between the individual resistors other behaviors of the digital-analog converter may be achieved.

For n force sensors and, for example, n strain gauges, n digital analog converters may be used. Thus, the force detection offset for each force sensor may easily be taken into account via a modularity with an evaluation device. A hardware adaptation of the evaluation device, for example via several digital-to-analog converters provided in the hardware of the evaluation device, is not necessary, but rather the digital outputs or pins that are normally present in such evaluation devices can be used. Digital-to-analog converters may then be used in a modular fashion, and depending on the number of digital outputs, any number of digital-to-analog converters.

Further embodiments and designs of the present disclosure can be found in the following item list:

1. A method for recognizing an actuation of a closure element (10) of a motor vehicle, wherein the method comprises at least the following steps:
detecting (20) an actuation force profile acting on the closure element (10), in particular on a handle element (12) of the closure element (10), and
recognizing (22) an actuation event in dependency of the detected actuation force profile.

2. The method according to item 1,
wherein the method comprises a step of detecting (18) a temperature of the handle element (12) with an integrated temperature sensor of a control device, and
wherein at least one of detecting (20) the actuation force profile and recognizing (22) the actuation event is conducted in dependency of the detected temperature of the handle element (12).

3. The method according to one of the preceding items,
wherein at least one of detecting (20) the actuation force profile and recognizing (22) the actuation event is conducted in dependency of an age of the handle element (12).

4. The method according to one of the preceding items,
wherein detecting (20) the actuation force profile comprises detecting (20a) a first actuation force profile with a first sensor (13a) and detecting (20b) a second actuation force profile with a second sensor (13b), wherein the first and the second sensor (13a, 13b) are spatially spaced apart from one another.

5. The method according to item 4,
wherein the method comprises a step of determining (23) an application point of an actuation force and/or determining (24) a direction of an actuation force based on the detected first and second actuation force profile.

6. The method according to item 4 or 5,
wherein recognizing (22) the actuation event comprises comparing (25) the first and second actuation force profile.

7. The method according to one of the preceding items,
wherein detecting (20) the actuation force profile is conducted at a reduced sampling rate after a specific time period without a recognized actuation event.

8. The method according to one of the preceding items,
wherein the step (22) of recognizing the actuation event comprises calculating an actuation probability,
wherein the actuation event is recognized if the calculated actuation probability is greater than a first threshold value,
in particular wherein the first threshold value is determined in dependency of the detected actuation force profile.

9. The method according to item 8,
wherein a wake-up signal is generated when the calculated actuation probability is greater than a second threshold value,
in particular wherein the second threshold value is smaller than the first threshold value.

10. The method according to item 8 or 9,
wherein the actuation force profile (90) comprises a level (92), a slope (94) and a standard deviation (96) as properties,
wherein calculating the actuation probability (100) comprises calculating individual probabilities (102, 104, 106) for an actuation,
wherein the individual probabilities (102, 104, 106) for an actuation are each calculated only in dependence of one of the properties, and
wherein the actuation probability (100) is calculated based on at least one of the calculated individual probabilities (102, 104, 106).

11. The method according to item 10,
wherein the same value is calculated for the individual probability (102, 104, 106) in, in each case, one range of the respective property.

12. The method according to items 10 or 11,
wherein the actuation probability (100) is calculated based on only one or two of the calculated individual probabilities (102, 104, 106).

13. The method according to items 10 to 12,
wherein recognizing (22) the actuation event is conducted in dependency of the standard deviation.

14. The method according to items 10 to 13,
wherein, if the standard deviation is above a third threshold, calculating the actuation probability is conducted solely in dependency of the individual probability with respect to the level or the slope, for example in dependency of two individual probabilities with respect to two levels or two slopes at different times.

15. The method according to one of the items 10 to 14,
wherein an actuation event is recognized when the slope is below a fourth threshold and the level is above a fifth threshold for a specific minimum duration.

16. The method according to one of the preceding items,
wherein the method comprises a step of detecting (26) a speed of the motor vehicle and recognizing (22) the actuation event is deactivated if the detected speed is greater than a threshold speed.

17. The method according to one of the preceding items,
wherein an opening signal is generated if at least one parameter of the detected actuation force profile is greater than a bridging threshold value, irrespective of whether the actuation event has been recognized.

18. The method according to one of the preceding items,
wherein the method comprises a step of determining (38) a first derivative of the detected actuation force profile and
recognizing (22) the actuation event occurs in dependency of the determined first derivative of the detected actuation force profile.

19. The method according to one of the preceding items,
wherein the method comprises a step of determining a second derivative of the detected actuation force profile and
recognizing the actuation event occurs in dependency of the determined second derivative of the detected actuation force profile.

20. The method according to one of the preceding items,
wherein that the method comprises a step of determining an interference signal in dependency of the detected actuation force profile.

21. The method according to item 20,
wherein recognizing (22) an actuation event occurs in dependency of the determined interference signal and/or
wherein at least one threshold value is determined in dependency of the determined interference signal.

22. The method according to one of the preceding items,
wherein a force detection offset is taken into account when detecting the actuation force profile.

23. The method according to one of the preceding items,
wherein the force detection offset is determined in dependency of the detected actuation force profile,
wherein the determination of the force detection offset is suspended if a change in the detected actuation force profile is greater than a change threshold.

24. The method according to one of the preceding items, wherein the force detection offset is taken into account via an analog compensation.

25. A system for recognizing an actuation of a closure element (10) of a motor vehicle, in particular wherein the system is designed for conducting the method according to one of the preceding claims,
wherein the system comprises
a force detection device which is designed to detect an actuation force profile acting on the closure element (10), in particular a handle element (12) of the closure element (10), and
an evaluation device which is designed to recognize an actuation event in dependency of the detected actuation force profile.

26. The system according to item 25,
wherein the force detection device comprises a strain gauge as a force sensor.

27. The system according to item 26,
wherein the strain gauge is designed as a Wheatstone measuring bridge (72).

28. The system according to one of the items 25 to 27,
wherein the force detection device comprises a first force sensor and a second force sensor, which are configured independently of one another for detecting the actuation force profile.

29. The system according to item 28,
wherein the system comprises a first digital-to-analog converter (78a) for the first force sensor and a second digital-to-analog converter (78b) for the second force sensor, wherein both digital-to-analog converters (78a, 78b) are controlled via digital outputs (80) of the evaluation device (86), and wherein the digital-to-analog converters (78a, 78b) are configured for analog compensation of the actuation force profile by a force detection offset.

### BRIEF DESCRIPTION OF THE FIGURES

FIG. 1a illustrates in a schematic perspective view a closure element designed as a door of a motor vehicle.

FIG. 1b illustrates schematically an arrangement of several sensors in the handle element.

FIG. 2 illustrates schematically a method for recognizing an actuation of the closure element according to FIG. 1.

FIG. 3 schematically illustrates a data evaluation when recognizing the actuation of the closure element according to FIG. 1.

FIG. 4 illustrates in a diagram a detected force profile in a parked motor vehicle.

FIG. 5 illustrates in a diagram a detected force profile in a car wash.

FIG. 6 illustrates in a diagram a detected force profile during actual actuations of the closure element.

FIG. 7 schematically illustrates an actuation force profile.

FIGS. 8a-8c schematically illustrates calculating individual probabilities.

FIG. 9 schematically illustrates calculating an actuation probability based on individual probabilities.

FIG. 10 schematically illustrates an analog compensation of a force detection offset.

### DETAILED DESCRIPTION OF EMBODIMENTS

FIG. 1a illustrates in a schematic perspective view a closure element of a motor vehicle in designed as a door 10. The door 10 is automatically adjustable by means of an actuator between an open position, in which an access opening to an interior of the motor vehicle is unblocked, and a closed position, in which the access opening is blocked. The door 10 comprises a rigid handle element 12. In case of actuation of the handle element 12 by a user, for example by pulling on the handle element 12, the door 10 is to be opened. To do this, a door lock is released and an adjustment of the door 10 is controlled by the actuator in the direction of an open position. However, if the handle element 12 is affected otherwise, for example by cleaning brushes and cleaning cloths in a car wash, the door 10 should remain in its closed position.

In the handle element 12, as shown schematically in FIG. 1b, in one embodiment, a first sensor 13a and a second sensor 13b are arranged spatially apart from one another instead of just one sensor. FIG. 1b schematically shows a cross-section through the handle element 12 and in top view of the handle element 12, such as how a user standing in front of the handle element 12 and the closure element 10 would see the elements in case of a transparent handle element 12. The first sensor 13a is arranged at the top left and the second sensor 13b is arranged at the bottom right. In an alternative embodiment, the two sensors 13a, 13b may also be arranged on the same horizontal line and/or vertical line. Other spatial local arrangements of the two sensors 13a, 13b relative to one another are also possible, such as, for example, the first sensor 13a being arranged at the bottom left and the second sensor 13b at the top right.

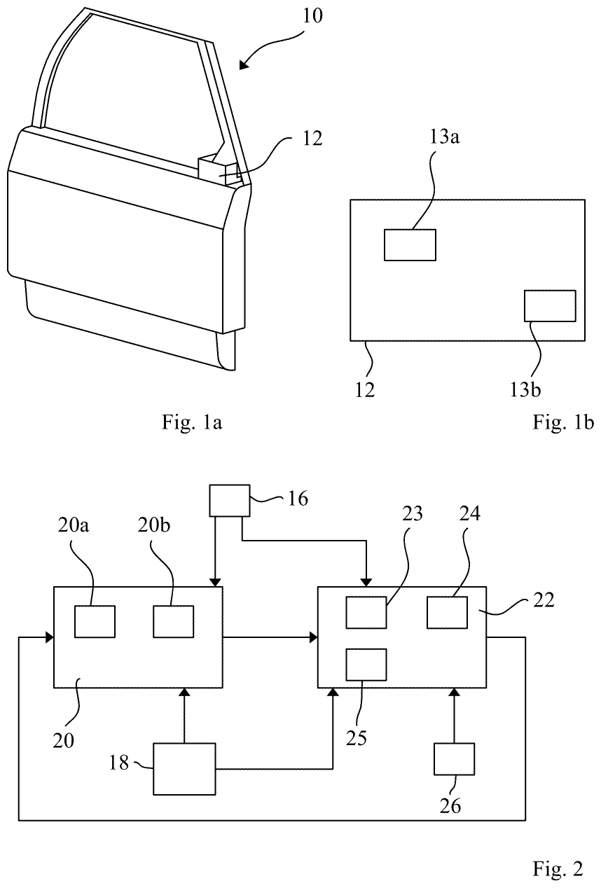

In FIG. 2 a method is illustrated with which the actuation of the door 10 of the motor vehicle is recognized. In a first step 20, an actuation force profile acting on the handle element 12 is detected. For this purpose, at least one strain gauge is integrated in the handle element 12 as a force sensor of a force detection device. In the event of deformation of the handle element 12, for example by pulling on the handle element 12, a measuring signal is generated which corresponds to the force acting on the handle element 12. In a step 22, recognizing an actuation event in dependency of the detected actuation force profile by means of an evaluation device occurs.

Furthermore, FIG. 2 shows that the method optionally comprises a step of detecting 18 a temperature of the handle element 12 according to an embodiment. The evaluation device, which is a control device, comprises an integrated temperature sensor for detecting 18. In one embodiment, detecting 20 the actuation force profile is conducted in dependency of the detected temperature of the handle element 12. In an alternative embodiment, recognizing 22 the actuation event is conducted in dependency of the detected temperature of the handle element 12. In a further embodiment, both detecting 20 the actuation force profile and recognizing 22 the actuation event are conducted in dependency of the detected temperature of the handle element 12. For example, different temperature curves when detecting 20 the actuation force profile may lead to different detected force profiles, whereby, for example, a temperature dependency of the rigidity of the handle element 12 can be compensated and thus the actuation force profile can be detected accurately.

Furthermore, it is shown in FIG. 2 that the method optionally comprises a step of determining 16 an age of at least one of the closure element 10 and the handle element 12. The age is determined by means of a timer implemented on the evaluation device. At least one of detecting 20 the actuation force profile and recognizing 22 the actuation event is conducted in dependency of the determined age of the closure element 10 and/or the handle element 12. The steps of detecting 18 the temperature and determining 16 the age may be conducted independently of one another.

Detecting 20 the actuation force profile in the embodiment with two sensors 13a, 13b comprises detecting 20a a first actuation force profile with the first sensor 13a and detecting 20b a second actuation force profile with the second sensor 13b.

Furthermore, the method may optionally comprise a step of determining 23 an application point of an actuation force based on the detected first and second actuation force profile in the step of recognizing 22 the actuation event. Furthermore, recognizing 22 the actuation event may comprise a step of determining 24 a direction of an actuation force based on the detected first and second actuation force profile. As shown in FIG. 1b exemplary, the two sensors 13a, 13b are arranged offset to each other both vertically and horizontally. This makes it possible to determine both an application point of the actuation force that a user exerts on the handle element 12 and a direction of this actuation force. Thus, for example, the user's actuation force may be resolved vectorially, i.e. the direction of the actuation force may be determined. This means that it is not only possible to determine whether the user is pushing or pulling, but also in which area of the handle element 12 the user is applying the force and in which direction he does.

Recognizing 22 the actuation event also comprises comparing 25 the first and second actuation force profiles. The first and second actuation force profile may be compared with each other at specific points in time or in specific ranges, for example. An actuation event can then be recognized based on this comparing. For example, if it is recognized that both the first and second actuation force profile comprise a certain value in a certain time range, an actuation event may be recognized. However, if only one of the first and second actuation force profile comprises a certain value, for example, no actuation event may be recognized.

FIG. 2 an optional feedback from the step of recognizing 22 the actuation event to the step of detecting 20 the actuation force profile according to the embodiment shown is further schematically shown. If no actuation event is recognized for a certain time period, detecting 20 the actuation force profile is conducted at a reduced sampling rate. Thus, detecting 20 the actuation force profile may initially be conducted at a first sampling rate. If no actuation event is recognized for a certain time period, such as a week, because the motor vehicle is parked and the user does not wish to open the door, the evaluation device may control detecting 20 based on recognizing 22 such that the sampling rate is reduced. With such a reduced, here second, sampling rate, which is lower than the first sampling rate, detecting 20 the actuation force profile can then be further conducted, for example until an actuation event is recognized again. After that, for example, the first sampling rate may be used again for detecting 20 the actuation force profile.

Furthermore, the method comprises a step of detecting 26 a speed of the motor vehicle. Recognizing 22 the actuation event is disabled in an embodiment when the detected speed is greater than a threshold speed, for example 3, 4 or 5 km/h. This may ensure that no actuation event is recognized when the motor vehicle is moving too fast.

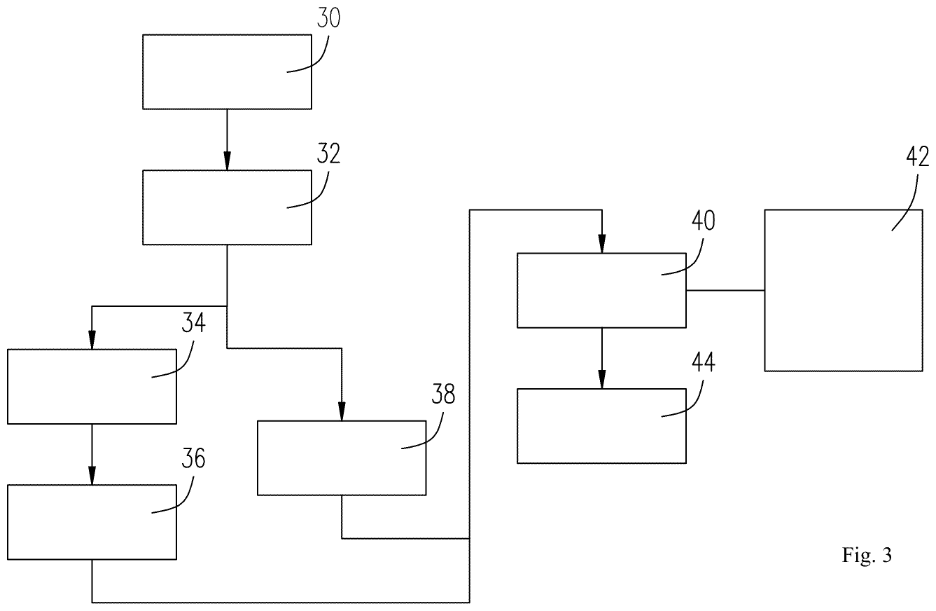

FIG. 3 schematically illustrates a data evaluation. In a step 30, the unprocessed sensor signal from the strain gauge is provided. In a step 32, this sensor signal is filtered with a low-pass filter to filter high-frequency force changes. High-frequency force changes do herein not correspond to an actuation by a user, but may be caused, for example, by electronic components on the circuit board. In a step 34, the detected actuation force profile is shifted by a force detection offset. Thus, a correction occurs of residual stresses remaining in the handle element 12 and of shifts caused by aging and temperature. This is explained in more detail in FIG. 6. In a step 36, a magnitude of the detected actuation force is determined, which here is a maximum value of a force during an actuation. In a step 38, a first derivative of the detected actuation force profile is determined, here a slope of the force during the actuation.

In a step 40, an actual analysis of the data generated in this way from the detected actuation force profile occurs in order to recognize possible actuation events in dependency of the detected actuation force profile. For this purpose, for example, the magnitude of the detected actuation force is compared with a minimum force as a threshold value. Likewise, for example, the first derivative of the detected actuation force is compared with a further threshold value. Depending on the extent of the exceedance, each of these characteristic values is assigned an actuation probability. Further threshold values may also be intended. For example, in case of an exceedance of a maximum force, the actuation probability is calculated as low. The maximum force may, for example, be a force that cannot normally be generated by a user, since an average person in a normal body posture is too weak for it. In addition, a form of a curve of the actuation force profile may be compared with known forms. Respective parameters used for recognizing the actuation event during the analysis were previously deposited in a step 42. These parameters are, for example, application-specific, customer-specific and vehicle-specific.

All calculated actuation probabilities of the comparisons described above are thereby multiplied with each other in order to calculate an overall actuation probability. If the calculated actuation probability is greater than a first threshold value, the actuation event is recognized in a step 44 and an actuation signal is generated. This actuation signal may control adjusting the door 10 into the open position. Optionally, a wake-up signal is generated even beforehand in step 44 if the calculated actuation probability is greater than a second threshold value, wherein the second threshold value is smaller than the first threshold value. Thus, the door opening may already be prepared even if the actuation event has not yet been recognized with sufficient certainty. Thus, door 10 may be opened with a particularly short delay when recognizing the actuation event.

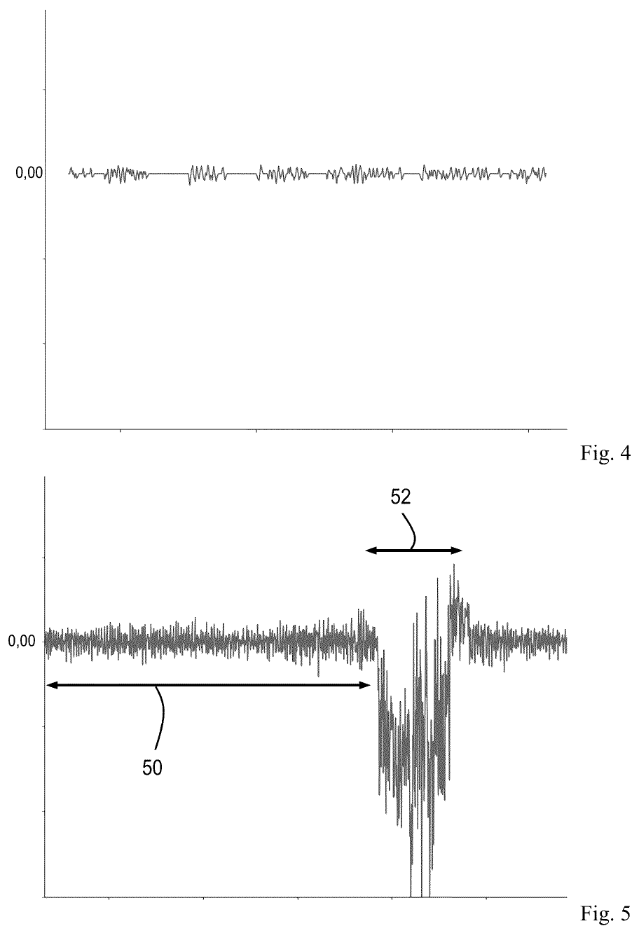

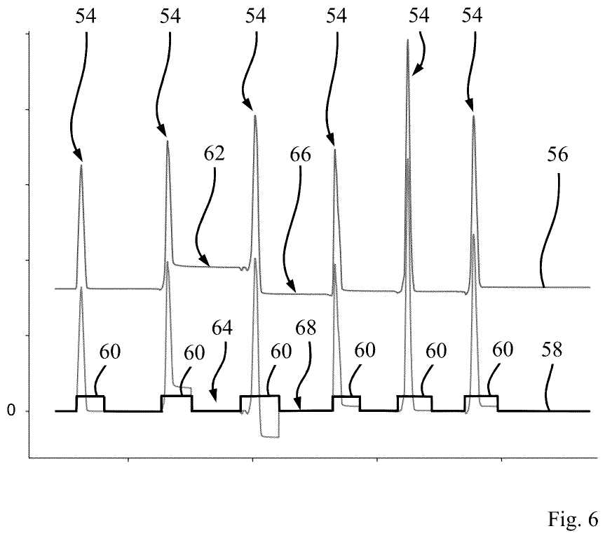

FIG. 4 illustrates a detected force profile at the handle element 12 in a parked vehicle. There are slight vibrations and thus deformations of the handle element 12, for example, due to other road users passing by. No operating event is recognized with such low forces. FIG. 5 illustrates a detected force profile at the handle element 12 when driving through a car wash. As can be seen in the range 50, the handle element 12 is thereby exposed to stronger vibrations, which are also essentially continuous, unlike with other road users passing by. In the range 52, a washing brush contacts the handle element 12, whereby the handle element 12 is exposed to large forces and thus deformations. However, no actuation event is recognized on the basis of the analysis and the consideration of the data and threshold values described above. An unwanted automatic opening of the door 10 in a car wash is thus avoided.

FIG. 6 illustrates in a diagram a detected actuation force profile during actual actuation of the door 10 or the handle element 12 by a user. Based on the shape of the force profile, the actuation event may be reliably recognized in the analysis. For example, it can be seen from the comparison with FIG. 5 that the actuation events in the ranges 54, here a pulling of the handle element 12, comprise a characteristic force profile with a well-defined force peak as maximum and steep, almost linear increase. In contrast, running the washing brush over the handle element 12 results in a much more irregular force profile with many successive local maxima in the range 52.

FIG. 6 comprises a first curve 56, which is an unprocessed detected actuation force profile. As can be recognized, an actuation force is permanently detected by the force sensor here—the force is never zero at any point in time. This zero offset is present in the example shown due to a sensor aging and/or external temperature changes. Therefore, the detected unprocessed actuation force profile is shifted by a force detection offset, whereby the second curve 58 is generated as compensated detected actuation force profile. The force detection offset corresponds to a moving average value of the first curve 56. The determination of the force detection offset and the moving average, respectively, is suspended herein if a change in the detected actuation force profile is greater than a change threshold. In the example shown, this is the case in the ranges 54. A duration of the suspension is illustrated by further characteristic curves 60. The suspension occurs by exceeding the change threshold and ends after a fixedly preset time period after falling below this change threshold. Correspondingly, as can be seen in FIG. 6, the suspension of the determination of the force detection offset is different in length and dependent on the detected actuation force profile.

In a range 62 of the first curve 56, it can also be seen that after an actuation of the handle element 12, a residual voltage remained in the handle element 12. Thus, even when the handle element 12 is not actuated, a force is detected which is higher than after the other actuation events and is caused mechanically rather than by aging and temperature fluctuations. This results in a larger force detection offset in this range 62, so that in a corresponding range 64 of the second curve 58 and the compensated actuation force profile, respectively, corresponds again to zero. In this case, the force in the range 64 may correspond to zero again. A step can also be recognized at the end of the suspension of the determination of the force detection offset. During a further subsequent actuation, the residual stress in the handle element 12 is released again, whereby a range 66 of the unprocessed detected actuation force profile returns to the, due to aging and temperature, usual force value for unactuated handle element 12. The previously usual force detection offset occurs again in this range 66, so that in a thereto corresponding range 68 of the second curve 58 and of the compensated actuation force profile, respectively, correspond again to zero. In this case, the force in the range 68 may correspond to zero. A step can also be seen at the end of the suspension of the determination of the force detection offset, but here in the opposite direction. Residual stresses in the handle element 12 may therefore also be compensated in order to improve a reliability of recognizing respective actuation events.

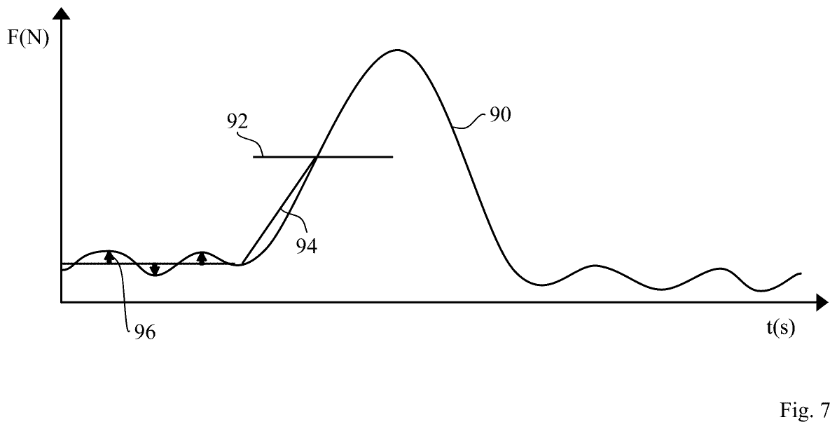

FIG. 7 schematically illustrates an actuation force profile. The actuation force profile 90 according to a particular embodiment is shown, wherein the actuation force profile 90, shown in FIG. 7, plots an actuation force on the vertical axis against time on the horizontal axis. Furthermore, a certain level 92, a certain slope 94 and a certain standard deviation 96 of the actuation force profile 90 are shown. The standard deviation 96 corresponds here to a spread of individual measuring points of the actuation force profile 90. The level 92 is determined with respect to an actuation force at a specific point in time and can be determined for different points in time. The slope 94 is determined with respect to two specific points in time and here, for example, as the average slope 94 of the actuation force profile 90 between the two points in time. Alternatively, the slope 94 may also be determined as the slope at a point, i.e. as the first derivative of the actuation force profile at a specific point in time. The standard deviation 96 is determined with respect to specific values of the actuation force profile in a specific time range. Both the slope 94 and the standard deviation 96 can also be determined for different points in time of the actuation force profile.

Calculating the actuation probability comprises calculating individual probabilities for an actuation. The individual probabilities for an actuation are calculated in each case and in dependency of one of the characteristics. Thus, one individual probability is calculated for level 92, another individual probability for slope 94, and yet another individual probability for standard deviation 96, in each case and in dependency of the respective characteristic.

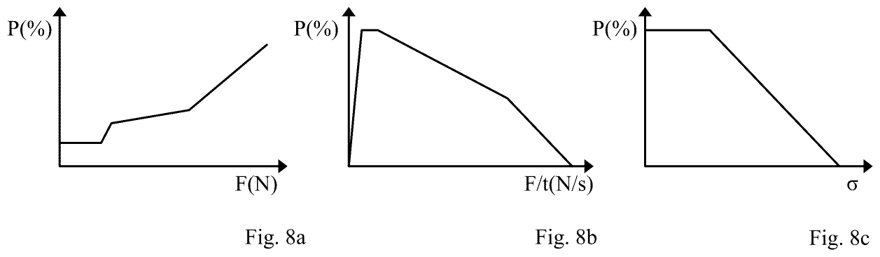

FIGS. 8a to 8c schematically illustrate calculating the individual probabilities. FIG. 8a shows schematically calculating the individual probability for level 92. FIG. 8b shows schematically calculating the individual probability for slope 94 and FIG. 8c shows schematically calculating the individual probability for the standard deviation 96. In FIG. 8a, the individual probability is plotted against the force, in FIG. 8b against the force per time, i.e. the slope of the force, and in FIG. 8c against the standard deviation. It can be seen that a certain individual probability is assigned to a certain value in each case. For example, it can be seen in FIG. 8a that with increasing force, i.e. with increasing level 92, the individual probability for level 92 also increases. With respect to the slope 94, it can be seen in FIG. 8b that the highest individual probability is reached in a medium area of the slope. With respect to the standard deviation 96, it can be seen in FIG. 8c that the individual probability for the standard deviation 96 decreases as the standard deviation 96 increases. In specific ranges of the values of level, slope and standard deviation, the value of the individual probability is maximal, while the value of the individual probability is not maximal outside these ranges. FIGS. 8a, 8b and 8c also show that the same value is calculated for the individual probability in a range of a respective property. Thus, the same individual probability value may be calculated for different levels, slopes or standard deviations.

The actuation probability is calculated based on at least one of the calculated individual probabilities. For example, the actuation probability may be calculated based on only one or two of the calculated individual probabilities. Alternatively, the actuation probability is calculated based on all three calculated individual probabilities. Furthermore, in alternative embodiments, which are not shown in detail here, further individual probabilities, which are not described in detail here, may be calculated and used for calculating the actuation probability.

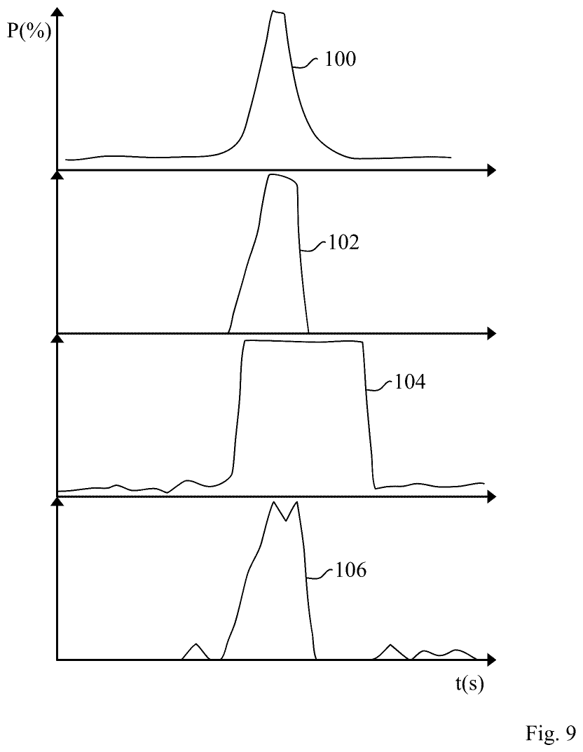

FIG. 9 schematically illustrates calculating the actuation probability, or the overall actuation probability, based on the calculated individual probabilities. FIG. 9 shows the probability on the vertical axis and the time on the horizontal axis, respectively. The separate probabilities 100, 102, 104, 106 are aligned with respect to each other and with respect to the time and arranged one above each other. The actuation probability 100 is shown at the top. Furthermore, the individual probability 102 for the level 92, the individual probability 104 for the slope 94 and the individual probability 106 for the standard deviation 96 is arranged one above the other and below the actuation probability 100. The individual probabilities 102, 104, 106 were calculated as described above, in particular for several points in time. Now, the actuation probability 100 is calculated from these individual probabilities 102, 104, 106 by multiplication. Alternatively, the actuation probability 100 can also be calculated from the individual probabilities 102, 104, 106 by integration, averaging or summation or other operators. For each point in time the actuation probability is calculated on the individual probability values. This occurs for a time range so that the profile of the actuation probability 100 curve is obtained.

For different use cases, the actuation force profile comprises different values for the properties level, slope and standard deviation. For example, the use case of normal opening by the user may have a high level and a moderate slope, while tapping by the user on the handle element 12 may have a medium to high level and a steep slope. Other use cases comprise different characteristics. An actuation event can be precisely recognized by the different characteristics and their values.

Recognizing 22 may further be conducted in dependency not only of the individual probabilities, but also of the standard deviation itself. For example, if the standard deviation is above a third threshold, calculating the actuation probability may be conducted solely in dependency of the individual probabilities with respect to the level or slope. For example, calculating may also be conducted in dependency of multiple individual probabilities with respect to only one property. In this way, the actuation probability can be calculated in dependency of two or more individual probabilities with respect to the level or with respect to two or more individual probabilities with respect to the slope. The two or more individual probabilities of the same property may have been calculated with respect to different points in time.

An actuation event may also be recognized if the slope is below a fourth threshold and the level is above a fifth threshold for a certain minimum duration. Thus, it can be recognized accurately that the user is pulling or pushing with a specific force on the handle element 12. The actuation event can be recognized accurately.

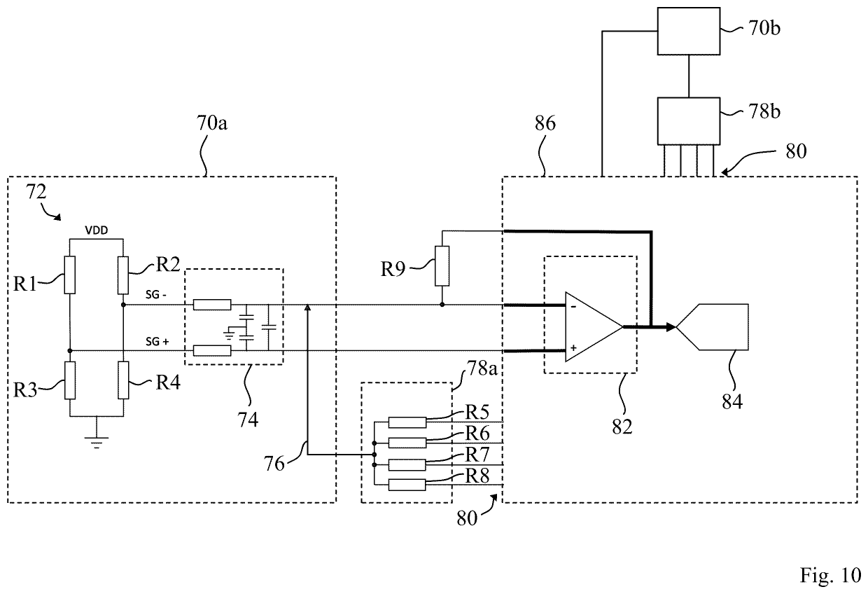

FIG. 10 schematically illustrates an analog compensation of a force detection offset. A Wheatstone measuring bridge 72 is shown schematically, which comprises the resistors R1 to R4 and which forms a force sensor for the detection of the actuation force profile. The resistors R1 to R4 each have an identical electrical resistance, for example 1200 ohm. The Wheatstone measuring bridge 72 is part of an analog signal conditioner 70a. Not shown in detail is a second Wheatstone measuring bridge of a further analog signal conditioning 70b, which forms the optional second force sensor for the detection of the actuation force profile. The system thus forms one or two strain gauges for recognizing an actuation, each strain gauge being designed as a force sensor as such a Wheatstone measuring bridge 72 as shown here schematically. The two force sensors are designed to detect an actuation force profile independently of each other. In this case, a potential VDD is applied to the Wheatstone measuring bridge 72 for supply. Furthermore, potentials SG−, SG+ are shown, which are used for detection 20 of the actuation force profile.

Furthermore, a microcontroller 86 is shown schematically in FIG. 10, which may form the evaluation device for at least partially executing steps of the method. The microcontroller 86 comprises an amplifier 82 and an analog-digital converter 84. The analog signal conditioning 70a is electrically connected to the microcontroller 86. Furthermore, a filter 74 is shown as part of the analog signal conditioning 70a, via which the Wheatstone measuring bridge 72 is connected to the amplifier 82. By this, time profiles of the potentials SG−, SG+ are filtered by the filter 74 and amplified by the amplifier 82. Then this analog signal is converted into a digital signal by the analog-digital converter 84 in order to obtain a digital signal with respect to the actuation force profile.

Furthermore, the microcontroller 86 comprises 80 digital outputs. The digital outputs 80 are designed as three-state outputs, so-called tri-state outputs 80. Either 0 V, a supply voltage of the microcontroller 86 or a high impedance may be applied to each output of the digital outputs 80. Furthermore, the system comprises digital-to-analog converters 78a and 78b. An analog signal conditioning 70a, 70b is connected to the microcontroller 86 via one such digital-to-analog converter 78a, 78b.

The digital-to-analog converter 78a comprises four resistors R5 to R8, which may be designated as bits. The resistors R5 to R8 are spaced from each other with respect to their electrical resistances by a factor of 3. For example, resistor R5 comprises an electrical resistance of 17400 ohm, resistor R6 comprises an electrical resistance of 52300 ohm, resistor R7 comprises an electrical resistance of 158000 ohm and resistor R8 comprises an electrical resistance of 470000 ohm. Using the three-state outputs, 81 states can be represented with the digital-to-analog converter 78a. Due to the factor of 3 between resistors R5 to R8 an almost linear resolution as output of the digital-analog converter 78a may be formed. Via an electrical connection 76, the output of digital-analog converter 78a may be applied to the filtered value of the actuation force profile. This may be used to shift the detected actuation force profile, for example by the force detection offset. The shifting is purely analog, and is achieved by adding the electrical voltage present at the digital-to-analog converter 78a to the electrical voltage output by the force sensor as measurement signal.

Both digital-to-analog converters 78a, 78b are configured for analog compensation of the actuation force profile by a force detection offset. The two different digital-to-analog converters 78a, 78b may be controlled differently via the digital outputs 80 in order to compensate for a respective individual force detection offset of a respective individual Wheatstone measuring bridge 72 and strain gauges.

Another resistor R9 is shown, via which an amplification of the actuation force profile may be implemented, for example an additional amplification for amplification of the amplifier 82.

With reference to the steps schematically shown in FIG. 3, determining 23 of the application point of the actuation force, determining 24 of the direction of the actuation force and comparing 25 of the first and second actuation force profile may be conducted as part of the analysis 40 of the data. The step of analyzing 40 may be conducted in dependency of the step of determining 16 the age of the closure element 10 and/or the handle element 12. The step of analyzing 40 may be conducted in dependency of the step of detecting 18 the temperature. The step of the analysis 40 may be conducted in dependency of detecting 26 the speed. Alternatively, or additionally, the step of recognizing 44 may be conducted in dependency of at least one of the steps of determining 16, 23, 24, comparing 25 and detecting 18, 26. Calculating probabilities, such as one, several or all individual probabilities and/or the actuation probability, may be conducted in at least one of the steps of analyzing 40 and recognizing 44.

### LIST OF REFERENCE SIGNS

10 Closure element/door
12 Handle element
16 Step: Determining age of the closure element/handle element
18 Step: Detecting temperature
20 Step: Detecting actuation force profile
20a Step: Detecting first actuation force profile
20b Step: Detecting second actuation force profile
22 Step: Recognizing actuation event
23 Step: Determining application point of an actuation force
24 Step: Determining direction of an actuation force
25 Step: Comparing first and second actuation force profile
26 Step: Detecting speed
30 Step: Supply of the unprocessed sensor signal
32 Step: Filtering sensor signal with low-pass filter
34 Step: Shift actuation force profile
36 Step: Determination magnitude of the actuation force
38 Step: Derivation of the actuation force profile
40 Step: Analysis of the data
42 Step: Deposit comparative parameters
44 Step: Recognizing actuation event and generation actuation signal
50 Range: background vibration car wash
52 Range: contact washing brush with handle element
54 Range: actuation by pulling on the handle element
56 First curve/non-offset actuation force profile
58 Second curve/offset actuation force profile
60 Characteristic curve duration suspension
62 Range: remaining residual voltage
64 Corresponding range
66 Range: usual force value
68 Corresponding range
70a, b Analog signal conditioning
72 Wheatstone measuring bridge
74 Filter
76 Electrical connection
78a, b Digital-to-analog converter
80 Digital outputs
82 Amplifier
84 Analog-to-digital converter
86 Microcontroller
90 Actuation force profile
92 Level
94 Slope
96 Standard deviation
100 Actuation probability
102 Individual probability level
104 Individual probability slope
106 Individual probability standard deviation
SG−, SG+ Potentials
R1-R9 Resistor
VDD Potential

1. A method for recognizing an actuation of a closure element of a motor vehicle, wherein the method comprises at least the following steps:
detecting an actuation force profile acting on the closure element, in particular on a handle element of the closure element, and
recognizing an actuation event in dependency of the detected actuation force profile.

2. The method according to claim 1,
wherein the method comprises a step of detecting a temperature of the handle element with an integrated temperature sensor of a control device, and
wherein at least one of detecting the actuation force profile and recognizing the actuation event is conducted in dependency of the detected temperature of the handle element.

3. The method according to claim 1,
wherein detecting the actuation force profile comprises detecting a first actuation force profile with a first sensor and detecting a second actuation force profile with a second sensor,
wherein the first and the second sensor are spatially spaced apart from one another.

4. The method according to claim 3,
wherein the method comprises a step of determining an application point of an actuation force and/or determining a direction of an actuation force based on the detected first and second actuation force profile.

5. The method according to claim 1,
wherein detecting the actuation force profile is conducted at a reduced sampling rate after a specific time period without a recognized actuation event.

6. The method according to claim 1,
wherein the step of recognizing the actuation event comprises calculating an actuation probability,
wherein the actuation event is recognized if the calculated actuation probability is greater than a first threshold value,
in particular wherein the first threshold value is determined in dependency of the detected actuation force profile.

7. The method according to claim 6,
wherein the actuation force profile comprises a level, a slope and a standard deviation as properties,
wherein calculating the actuation probability comprises calculating individual probabilities an actuation,
wherein the individual probabilities for an actuation are each calculated only in dependence of one of the properties, and
wherein the actuation probability is calculated based on at least one of the calculated individual probabilities.

8. The method according to claim 1,
wherein the method comprises a step of detecting a speed of the motor vehicle and recognizing the actuation event is deactivated if the detected speed is greater than a threshold speed.

9. The method according to claim 1,
wherein a force detection offset is taken into account when detecting the actuation force profile.

10. The method according to claim 9,
wherein the force detection offset is determined in dependency of the detected actuation force profile,
wherein the determination of the force detection offset is suspended if a change in the detected actuation force profile is greater than a change threshold.

11. The method according to claim 9,
wherein the force detection offset is taken into account via an analog compensation.

12. A system for recognizing an actuation of a closure element of a motor vehicle, in particular wherein the system is designed for conducting the method according to claim 1,
wherein the system comprises
a force detection device which is designed to detect an actuation force profile acting on the closure element, in particular a handle element of the closure element, and
an evaluation device which is designed to recognize an actuation event in dependency of the detected actuation force profile.

13. The system according to claim 12,
wherein the force detection device comprises a strain gauge as a force sensor, wherein the strain gauge is designed as a Wheatstone measuring bridge.

14. The system according to claim 12,
wherein the force detection device comprises a first force sensor and a second force sensor, which are configured independently of one another for detecting the actuation force profile.

15. The system according to claim 14,
wherein the system comprises a first digital-to-analog converter for the first force sensor and a second digital-to-analog converter for the second force sensor, wherein both digital-to-analog converters are controlled via digital outputs of the evaluation device, and wherein the digital-to-analog converters are configured for analog compensation of the actuation force profile by a force detection offset.
